(19) United States
(12) Patent Application Publication
(10) Pub. No.: US 2024/0336148 A1
(43) Pub. Date: Oct. 10, 2024

(54) DRIVE UNIT AND VEHICLE HAVING SUCH A DRIVE UNIT

(71) Applicant: Vitesco Technologies GmbH, Regensburg (DE)

(72) Inventors: Matthias Bleeck, München (DE); Olivier Frament, München (DE); Martin Brüll, München (DE); Henry Meißgeier, München (DE); Günter Reitinger, München (DE)

(21) Appl. No.: 18/627,910

(22) Filed: Apr. 5, 2024

(30) Foreign Application Priority Data
Apr. 6, 2023 (DE) 10 2023 203 216.3

(51) Int. Cl. B60L 15/20

(52) U.S. Cl. CPC B60L 15/2009; B60L 2240/421

(57) ABSTRACT

A drive unit for an electrically driven vehicle, having an electric machine, for accelerating and/or braking the vehicle, a transmission unit, which is designed to transform a rotational speed of an output shaft of the electric machine to an output rotational speed of a transmission output shaft of the transmission unit, a friction brake unit having a functional fluid for cooling and/or lubrication, to convert kinetic energy of the transmission output shaft into thermal energy by friction, and a housing having a first housing region, in which the electric machine is arranged, a second housing region, in which the transmission unit is arranged, and a third housing region, in which the friction brake unit is arranged. The first housing region, the second housing region and the third housing region are formed integrally with one another, and at least the third housing region is sealed off with respect to the environment.

### CROSS REFERENCE TO RELATED APPLICATIONS

This application which claims priority to German Patent Application No. 10 2023 203 216.3, filed Apr. 6, 2023, the contents of such application being incorporated by reference herein.

### FIELD OF THE INVENTION

The present invention relates to a drive unit, in particular a drive unit for an electrically driven vehicle. The present invention also relates to a vehicle having such a drive unit and in particular an automobile having such a drive unit.

### BACKGROUND OF THE INVENTION

Drive units of modern vehicles must meet increasingly stricter requirements with regard to emissions and environmental regulations. Thus, in the future, for example, particle emissions and energy consumption of drive units will be regulated more strictly. Added to this is the fact that modern drive units have to meet the increasingly stricter requirements with regard to overall space, integration and modularity.

### SUMMARY OF THE INVENTION

It is therefore an aim of the present invention to provide a drive unit, in particular for an electrically driven vehicle, which meets these strict requirements.

According to a first aspect of the present invention, a drive unit, in particular for an electrically driven vehicle, is provided, wherein the drive unit has: an electric machine, which is designed as an electric motor or generator to accelerate and/or to brake the vehicle, a transmission unit arranged adjacent to the electric machine, which is designed to transform a rotational speed of an output shaft of the electric machine into an output rotational speed of the transmission output shaft of the transmission unit, and a friction brake unit, arranged adjacent to the transmission unit and supplied with a functional fluid for cooling and/or lubrication, which is designed to convert or dissipate kinetic energy of the transmission output shaft into thermal energy by means of friction. The drive unit according to an aspect of the invention also has a housing, which has a first housing region, in which the electric machine is arranged, a second housing region, in which the transmission unit is arranged, and a third housing region, in which the friction brake unit is arranged. In the housing, the first housing region, the second housing region and the third housing region are formed integrally with one another. In other words, this is a single housing in which there are three housing regions, wherein a respective housing region is provided for a respective component of the drive unit. In the drive unit according to an aspect of the invention, at least the third housing region is sealed off with respect to the environment, so that neither particles which can arise during operation of the friction brake unit nor functional fluid from the third housing region is discharged into the environment. The integration of the three components, electric machine, transmission unit and friction brake unit, in a single housing is space-saving, compact and forms a highly integrated drive unit. Displacing the friction brake unit into the drive unit, that is to say away from the wheel, creates synergies, since fewer control devices, lines, housings, thermal systems etc. are needed. The use of a friction brake unit supplied with lubricating and/or cooling functional fluid permits the friction brake unit to be encapsulated in the housing. As a result, the wheel can be covered, which means that advantages in terms of aerodynamics and consumption are achieved. In addition, particles and dust from the friction brake unit remain in the interior of the housing, that is the say do not get into the environment, whereby emissions are reduced. The drive unit according to an aspect of the invention thus meets the most modern requirements with regard to emission, integration, modularity and overall space.

In a preferred refinement, the electric machine, the transmission unit and the friction brake unit are arranged coaxially in the housing, i.e. along a common axis. As a result, the overall space is reduced further.

In a further preferred refinement, the friction brake unit is a (multi-) disk brake unit and/or the electric machine is an axial flow machine. The disk brake unit is an efficient and compact friction brake unit, which can be accommodated in an encapsulated housing without any air cooling. The axial flow machine, with its magnets aligned in the direction of the output shaft of the axial flow machine, is not only particularly space-saving, in particular given a coaxial arrangement of the components, but also an efficient electric machine which needs little overall space.

Expediently, the transmission unit is arranged between the electric machine and the friction brake unit.

In a further advantageous refinement, the housing has one or more supply openings for the functional fluid of the friction brake unit. The supply openings are used, for example, to supply and/or discharge the functional fluid, for example for a circulation and/or during a replacement of the functional fluid.

A further advantageous refinement provides for the third housing region to have a fluid connection to the second housing region in such a way that the functional fluid of the friction brake unit can also be used for cooling and/or lubricating the transmission unit. This advantageous refinement is based at least partly on the finding that the functional fluid of the friction brake unit is also usable as a functional fluid for the transmission unit. As a result, the transmission unit and the friction brake unit can be supplied by means of the same functional fluid, which creates further synergies. In this preferred refinement, the third housing region is fluidly connected to the second housing region, so that the functional fluid can be used both in the second and in the third housing region. In order to avoid the functional fluid overflowing into the first housing region, in which the electric machine is arranged, the second housing region can also be designed to be fluid-tight with respect to the environment and in particular with respect to the first housing region.

In a further preferred refinement, the third housing region is fluidly connected to the first housing region in such a way that the functional fluid of the friction brake unit can also be used for cooling and/or lubricating the electric machine. This advantageous refinement is based at least partly on the finding that the functional fluid of the friction brake unit can also be used for the electric machine. In order to achieve this, for example, the first housing region could have a fluid connection via the second housing region to the third housing region, so that the functional fluid can ultimately be used in all three housing regions. Alternatively, it is also possible for only the third housing region to have a fluid connection to the first housing region, so that the functional fluid can be used only in the third housing region and in the first housing region. In any case, it is ensured that no undesired escape of the functional fluid, nor any undesired escape of particles from the friction brake unit which may possibly be present in the functional fluid, into the environment can take place. Thus, for example, the third and first and/or also the second housing region can be sealed off with respect to the environment.

In a further preferred refinement, the transmission output shaft is designed to be connected to a wheel input shaft of a wheel of the vehicle. For example, the transmission output shaft and wheel input shaft can be connectable to each other by means of one or more joints. As a result, the wheel can be accelerated via the electric machine and braked via the electric machine and/or the friction brake unit.

A second aspect of the present invention comprises a vehicle having a drive unit according to the first aspect or refinements thereof. The vehicle is in particular an electrically operated vehicle. An electrically operated vehicle can be an FCEV (fuel cell electric vehicle), a BEV (battery electric vehicle), an HEV (hybrid electric vehicle), a PHEV (plug-in hybrid electric vehicle) or another electrically operated vehicle.

### BRIEF DESCRIPTION OF THE DRAWINGS

Further features and objects of aspects of the present invention will become apparent to a person skilled in the art by practicing the present teaching and taking into consideration the accompanying drawings, in which:

FIG. 1 shows a schematic view of an embodiment of a drive unit according to the invention;

FIG. 2 shows a schematic view of a further embodiment of a drive unit according to the invention;

FIG. 3 shows a schematic view of a further embodiment of a drive unit according to the invention; and

FIG. 4 shows a schematic view of a further embodiment of a drive unit according to the invention.

### DETAILED DESCRIPTION OF THE PREFERRED EMBODIMENTS

Elements of the same design or function are provided with the same designations throughout the figures.

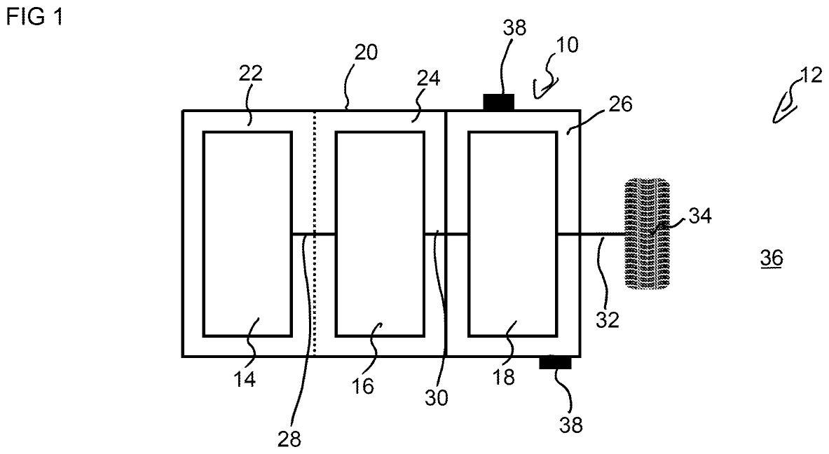

Reference is made first to FIG. 1, in which a schematic view of an embodiment of a drive unit 10 according to the invention for an electrically operated vehicle 12 is shown. The drive unit 10 has an electric machine 14, a transmission unit 16 and a friction brake unit 18. The three components are arranged in a housing 20, which has three housing regions, wherein a respective housing region is provided for a respective component. Arranged in a first housing region 22 is the electric machine 14, which is used as an electric motor or generator for the vehicle 12. Arranged in a second housing region 24 is the transmission unit 16, which is arranged adjacent to the electric machine 14 in the housing 20. Arranged in a third housing region 26 is the friction brake unit 18, which is arranged adjacent to the transmission unit 16 in the housing 20. The transmission unit 16 is therefore arranged between the electric machine 14 and the friction brake unit 18.

In one embodiment, the electric machine 14 is an axial flow machine, the transmission unit 16 is a planetary gearbox and the friction brake unit 18 is a disk brake unit. However, in other embodiments, not shown, other electric machines, transmission units and/or friction brake units can also be provided.

The electric machine 14 has an output shaft 28, which is used as an input shaft for the transmission unit 16. The transmission unit 16 for its part has a transmission output shaft 30, which is used as an input shaft for the friction brake unit 18. The electric machine 14 is used as a traction machine for the acceleration (motor mode) and/or braking (generator mode) of the vehicle 12. The transmission unit 16 is used to transform a rotational speed of the output shaft 28 into an output rotational speed of the transmission output shaft 30. The friction brake unit 18 is used to convert or dissipate kinetic energy of the transmission output shaft 30 into thermal energy by means of friction. The transmission output shaft 30 is connected to a wheel input shaft 32 of a wheel 34 of the vehicle 12, so that the wheel 34 can be accelerated by means of the electrical machine 14 and braked/retarded by means of the electric machine 14 and/or the friction brake unit 18. As can be seen in FIG. 1, the electric machine 14, transmission unit 16 and friction brake unit 18 are arranged coaxially, that is to say along a common axis, in the housing 20.

The friction brake unit 18 is a friction brake unit cooled and/or lubricated with functional fluid. The friction brake unit 18 is therefore in particular not an air-cooled friction brake unit, such as for example a disk brake or the like. The friction brake unit 18 is lubricated and/or cooled by means of the functional fluid which, for example, can be an oil or the like, depending on the use and/or function of the functional fluid. For instance, the friction brake unit 18 can be bathed in the functional fluid. The friction brake unit 18 can, however, also be supplied with functional fluid only when needed, for example during braking. Depending on expediency and area of use, both and/or one of the variants are optionally conceivable.

The housing 20 has the three housing regions 22, 24 and 26 formed integrally with one another. The housing 20 can be produced, for example, by means of casting processes or the like. The housing 20 is a single housing. The housing regions 22-26 are used to receive a respective component 14-18 of the drive unit 10. The housing regions 22-26 can be separated chambers in the interior of the individual housing 20. However, the housing regions 22-26 can also be only portions in the housing 20 otherwise forming a common receiving space, depending on application and expediency. In the embodiment shown in FIG. 1, at least the third housing region 26 is sealed off with respect to the environment 36 in such a way that, in particular, an undesired escape of functional fluid and/or particles/dust from the friction brake unit 18 into the environment 36 is prevented. In the specific embodiment of FIG. 1, for example, the third housing region can be a chamber encapsulated with respect to the environment 36. Other expedient configurations are of course conceivable.

In the specific example of FIG. 1, the housing 20 also has supply openings 38 for supplying the third housing region 26 with functional fluid. Supply openings are used, for example, when the functional fluid is pumped in a circulation and/or when the functional fluid has to be replaced. Of course, it is conceivable that in other embodiments, not shown, there is (are) no supply opening(s) 38 for the functional fluid. This would be the case, for example, when the functional fluid did not have to be changed during the lifetime of the drive unit 10.

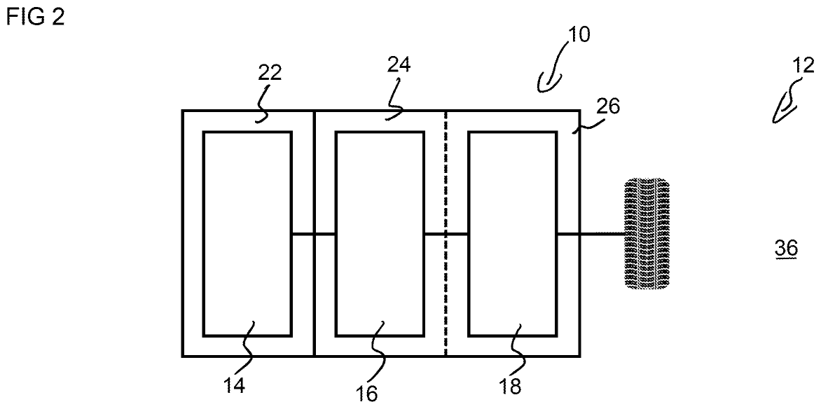

Reference is now made to FIG. 2, which shows a second embodiment of the drive unit 10 of the vehicle 12. In the embodiment according to FIG. 2, the third housing region 26 is fluidly connected to the second housing region 24. In the embodiment according to FIG. 2, the functional fluid can thus be used to supply the friction brake unit 18 and the transmission unit 16. In other words, the friction brake unit 18 and the transmission unit 16 share the same functional fluid. As a result, the friction brake unit 18 and the transmission unit 16 can be lubricated and/or cooled by means of the same functional fluid. In order to prevent functional fluid and possibly particles from the friction brake unit 18 from being discharged into the environment 36, the second housing region 24 and the third housing region 26 are sealed off with respect to the environment 36. As can be seen further in FIG. 2, the second housing region 24 has no fluid connection to the first housing region 22. The electric machine 14 arranged in the first housing region 22 is accordingly not supplied with the functional fluid of the friction brake unit 18 but, of course, can also be supplied with another functional fluid.

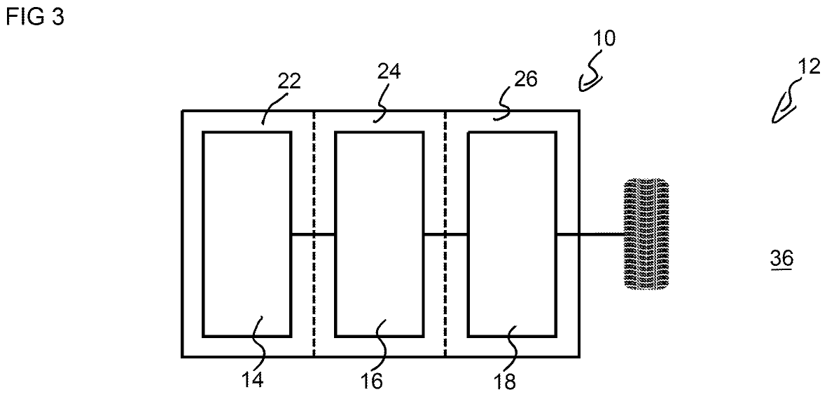

Reference is now made to FIG. 3, in which a third embodiment of the drive unit 10 of the vehicle 12 is shown. In the embodiment shown in FIG. 3, all three housing regions 22-26 have a fluid connection to one another. In particular, the third housing region 26 is fluidly connected to the first housing region 22 via the second housing region 24. As a result, the electric machine 14, the transmission unit 16 and the friction brake unit 18 can be supplied with the same functional fluid. In order in such a case also to prevent an undesired escape of functional fluid and/or particles into the environment 36, in the embodiment of FIG. 3 all three housing regions 22-26 are sealed off with respect to the environment 36. This can be achieved, for example, by the housing 20 being intrinsically sealed off with respect to the environment 36.

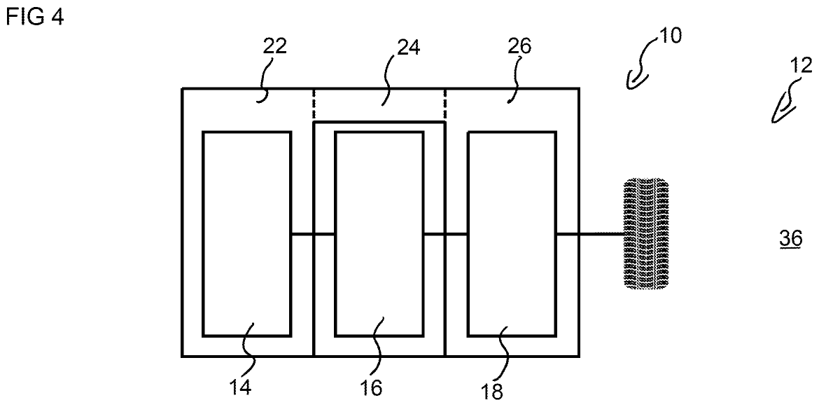

Reference is made finally to FIG. 4, which shows a fourth embodiment of the drive unit 10 of the vehicle 12. In the embodiment shown in FIG. 4, the third housing region 26 is fluidly connected only to the first housing region 22 but not to the second housing region 24. In the embodiment shown in FIG. 4, the functional fluid of the friction brake unit 18 thus supplies both the friction brake unit 18 and the electric machine 14 but not the transmission unit 16. Of course, the transmission unit 16 can be supplied by means of another functional fluid. In order in such a case also to prevent an undesired escape of functional fluid and/or particles into the environment 36, in the embodiment of FIG. 3 the third and first housing region 26, 22 are sealed off with respect to the environment 36.

The embodiments shown in connection with FIGS. 1 to 4 can of course be combined with one another in any desired expedient manner, depending on the application and area of use of the drive unit 10. Although supply openings 38 are shown only in connection with the embodiment described in FIG. 1, it is of course also conceivable that one or more supply openings for the functional fluid can be provided in the other embodiments according to FIGS. 2 to 4.

1. A drive unit for an electrically driven vehicle, wherein the drive unit comprises
an electric machine, which is designed to accelerate and/or brake the vehicle,
a transmission unit arranged adjacent to the electric machine, which is designed to transform a rotational speed of an output shaft of the electric machine to an output rotational speed of a transmission output shaft of the transmission unit, and
a friction brake unit arranged adjacent to the transmission unit and supplied with a functional fluid for cooling and/or lubrication, which is designed to convert kinetic energy of the transmission output shaft into thermal energy by means of friction, and
a housing having a first housing region, in which the electric machine is arranged, a second housing region, in which the transmission unit is arranged, and a third housing region, in which the friction brake unit is arranged, wherein the first housing region, the second housing region and the third housing region are formed integrally with one another, and
wherein at least the third housing region is sealed off with respect to the environment.

2. The drive unit as claimed in claim 1, wherein the electric machine, the transmission unit and the friction brake unit are arranged coaxially in the housing.

3. The drive unit as claimed in claim 1, wherein the friction brake unit is a multi-disk brake unit.

4. The drive unit as claimed in claim 1, wherein the electric machine is an axial flow machine.

5. The drive unit as claimed in claim 1, wherein the housing has one or more supply openings for the functional fluid.

6. The drive unit as claimed in claim 1, wherein the third housing region is fluidly connected to the second housing region in such a way that the functional fluid of the friction brake unit can also be used for cooling and/or lubricating the transmission unit.

7. The drive unit as claimed in claim 1, wherein the third housing region is fluidly connected to the first housing region in such a way that the functional fluid of the friction brake unit can also be used for cooling and/or lubricating the electric machine.

8. The drive unit as claimed in claim 1, wherein the transmission unit is arranged between the electric machine and the friction brake unit.

9. The drive unit as claimed in claim 1, wherein the transmission output shaft is designed to be connected to a wheel input shaft of a wheel of the vehicle.

10. A vehicle having a drive unit as claimed in claim 1.

11. The drive unit as claimed in claim 2, wherein the friction brake unit is a multi-disk brake unit.

12. The drive unit as claimed in claim 2, wherein the electric machine is an axial flow machine.

13. The drive unit as claimed in claim 2, wherein the housing has one or more supply openings for the functional fluid.
